(19) United States
(12) Patent Application Publication
(10) Pub. No.: US 2025/0273117 A1
(43) Pub. Date: Aug. 28, 2025

(54) DISPLAY DEVICE

(71) Applicant: Samsung Display Co., Ltd., Yongin-Si (KR)

(72) Inventor: JEONGEUN KIM, Yongin-si (KR)

(21) Appl. No.: 18/959,664

(22) Filed: Nov. 26, 2024

(30) Foreign Application Priority Data
Feb. 27, 2024 (KR) 10-2024-0028225

(51) Int. Cl. G09G 3/20

(52) U.S. Cl. CPC G09G 3/2092; G09G 3/2007; G09G 2310/0291; G09G 2310/08; G09G 2320/0686; G09G 2330/021; G09G 2330/028

(57) ABSTRACT

A display device includes a display panel including a plurality of pixels, a scan driver configured to provide scan signals to the plurality of pixels, a gamma voltage generator including a plurality of amplifiers that output a plurality of gamma voltages, a data driver configured to generate data voltages based on the plurality of gamma voltages, and to provide the data voltages to the plurality of pixels, and a controller configured to divide a display region of the display panel into a normal region and a simple display region having only predetermined colors, and to generate a flag signal having an active level in a time period corresponding to the simple display region within a frame period. The gamma voltage generator is configured to disable at least a portion of the plurality of amplifiers in response to the flag signal having the active level.

### CROSS-REFERENCE TO RELATED APPLICATION(S)

This application claims priority under 35 USC § 119 to Korean Patent Application No. 10-2024-0028225, filed on Feb. 27, 2024 in the Korean Intellectual Property Office (KIPO), the content of which is incorporated by reference herein in its entirety.

### BACKGROUND

### 1. Field

Embodiments of the present disclosure relate to a display device, and more particularly to a display device capable of reducing power consumption.

### 2. Description of the Related Art

A gamma voltage generator of a display device may generate a plurality of gamma voltages, and a data driver of the display device may provide data voltages to a plurality of pixels of a display panel based on the plurality of gamma voltages. For example, the data driver may receive the plurality of gamma voltages from the gamma voltage generator, may generate a plurality of gray level voltages respectively corresponding to a plurality of gray levels based on the plurality of gamma voltages, may select gray level voltages corresponding to image data among the plurality of gray level voltages, and provide the selected gray level voltages as the data voltages to the plurality of pixels.

### SUMMARY

Embodiments of the present disclosure provide a display device capable of reducing power consumption.

According to an embodiment, a display device comprises a display panel including a plurality of pixels, a scan driver connected to the plurality of pixels and providing scan signals to the plurality of pixels, a gamma voltage generator including a plurality of amplifiers that output a plurality of gamma voltages, a data driver connected to the gamma voltage generator, wherein the data driver generates data voltages based on the plurality of gamma voltages, and provides the data voltages to the plurality of pixels, and a controller connected to the scan driver, the gamma voltage generator and the data drive. The controller controls the scan driver, the gamma voltage generator and the data driver, divides a display region of the display panel into a normal region and a simple display region having only predetermined colors, and generates a flag signal having an active level in a time period corresponding to the simple display region within a frame period. The gamma voltage generator disables at least a portion of the plurality of amplifiers in response to the flag signal having the active level.

According to an embodiment, the plurality of amplifiers may include an uppermost amplifier configured to output an uppermost gamma voltage among the plurality of gamma voltages, a lowermost amplifier configured to output a lowermost gamma voltage among the plurality of gamma voltages, and intermediate amplifiers configured to output intermediate gamma voltages between the uppermost gamma voltage and the lowermost gamma voltage among the plurality of gamma voltages. In response to the flag signal having the active level, the gamma voltage generator may maintain the uppermost amplifier and the lowermost amplifier in an enable state, and may disable the intermediate amplifiers.

According to an embodiment, in response to the flag signal having the active level, the gamma voltage generator may maintain 2^{M} amplifiers among the plurality of amplifiers in an enable state, where M is an integer greater than 0, and may disable remaining amplifiers except for the 2^{M} amplifiers among the plurality of amplifiers.

According to an embodiment, the controller may receive simple display region position information indicating a position of the simple display region from a host processor, and may divide the display region of the display panel into the normal region and the simple display region based on the simple display region position information.

According to an embodiment, the controller may divide the display region of the display panel into the normal region and the simple display region by analyzing input image data for the display panel.

According to an embodiment, the controller may divide the input image data for the display panel into a plurality of line data for a plurality of pixel rows of the display panel. With respect to each line data of the plurality of line data, the controller may determine whether each of a plurality of pixel data included in the line data represents one of the predetermined colors, may determine that the line data is for the normal region when any one of the plurality of pixel data represents a color other than the predetermined colors, and may determine that the line data is for the simple display region when all of the plurality of pixel data represent the predetermined colors.

According to an embodiment, the predetermined colors may be a black color and a white color.

According to an embodiment, the predetermined colors may be a black color, a white color, a red color, a green color, a blue color, a yellow color, a cyan color and a magenta color.

According to an embodiment, the controller may include a simple display processing block configured to convert input image data for each of the plurality of pixels into maximum gray level data or minimum gray level data, and a plurality of processing blocks located subsequent to the simple display processing block, and configured to perform data processing operations. In response to the flag signal having the active level, the controller may enable the simple display processing block, and may disable the plurality of processing blocks.

According to an embodiment, in response to the flag signal having the active level, the simple display processing block may convert the input image data for each of the plurality of pixels into the maximum gray level data when a most significant bit of the input image data has a value of 1, and may convert the input image data for each of the plurality of pixels into the minimum gray level data when the most significant bit of the input image data has a value of 0.

According to an embodiment, the controller may further include a clock generator configured to provide an internal clock signal to the simple display processing block and the plurality of processing blocks. In response to the flag signal having the active level, the clock generator may provide the internal clock signal to the simple display processing block, and may not provide the internal clock signal to the plurality of processing blocks.

According to an embodiment, the controller may include a first simple display processing block configured to receive input image data for each of the plurality of pixels, and to output a most significant bit of the input image data for each of the plurality of pixels, a plurality of processing blocks located subsequent to the first simple display processing block, and configured to perform data processing operations, and a second simple processing display block located subsequent to the plurality of processing blocks, and configured to output maximum gray level data or minimum gray level data according to the most significant bit. In response to the flag signal having the active level, the controller may enable the first and second simple display processing blocks, and may disable the plurality of processing blocks.

According to an embodiment, the controller may further include a clock generator configured to provide an internal clock signal to the first simple display processing block, the plurality of processing blocks and the second simple display processing block. In response to the flag signal having the active level, the clock generator may provide the internal clock signal to the first and second simple display processing blocks, and may not provide the internal clock signal to the plurality of processing blocks.

According to an embodiment, a display device comprises a display panel including a plurality of pixels, a scan driver connected to the plurality of pixels and providing scan signals to the plurality of pixels, a data driver connected to the plurality of pixels and providing data voltages to the plurality of pixels, and a controller connected to the scan driver and the data driver to control the scan driver and the data driver. The controller divides a display region of the display panel into a normal region and a simple display region having only predetermined colors, generates a flag signal having an active level in a time period corresponding to the simple display region within a frame period, and disables a plurality of processing blocks of the controller in response to the flag signal having the active level.

According to an embodiment, the controller may include the plurality of processing blocks configured to perform data processing operations, and a clock generator configured to provide an internal clock signal to the plurality of processing blocks. In response to the flag signal having the active level, the clock generator may not provide the internal clock signal to the plurality of processing blocks.

According to an embodiment, the controller may further include a simple display processing block located in front of the plurality of processing blocks, and configured to convert input image data for each of the plurality of pixels into maximum gray level data or minimum gray level data.

According to an embodiment, the controller may further include a first simple display processing block located in front of the plurality of processing blocks, configured to receive input image data for each of the plurality of pixels, and configured to output a most significant bit of the input image data for each of the plurality of pixels, and a second simple processing display block located subsequent to the plurality of processing blocks, and configured to output maximum gray level data or minimum gray level data according to the most significant bit.

According to an embodiment, the display device may further include a gamma voltage generator including a plurality of amplifiers that output a plurality of gamma voltages. The gamma voltage generator may disable at least a portion of the plurality of amplifiers in response to the flag signal having the active level.

According to an embodiment, the plurality of amplifiers may include an uppermost amplifier configured to output an uppermost gamma voltage among the plurality of gamma voltages, a lowermost amplifier configured to output a lowermost gamma voltage among the plurality of gamma voltages, and intermediate amplifiers configured to output intermediate gamma voltages between the uppermost gamma voltage and the lowermost gamma voltage among the plurality of gamma voltages. In response to the flag signal having the active level, the gamma voltage generator may maintain the uppermost amplifier and the lowermost amplifier in an enable state, and may disable the intermediate amplifiers.

According to an embodiment, a display device comprises a display panel including a plurality of pixels, a scan driver connected to the plurality of pixels and providing scan signals to the plurality of pixels, a gamma voltage generator including a plurality of amplifiers that output a plurality of gamma voltages, a data driver connected to the gamma voltage generator, wherein the data driver generates data voltages based on the plurality of gamma voltages, and provides the data voltages to the plurality of pixels, and a controller connected to the scan driver, the gamma voltage generator and the data driver. The controller controls the scan driver, the gamma voltage generator and the data driver, divides a display region of the display panel into a normal region and a simple display region having only predetermined colors, and generates a flag signal having an active level in a time period corresponding to the simple display region within a frame period. The gamma voltage generator disables at least a portion of the plurality of amplifiers in response to the flag signal having the active level. The controller disables a plurality of processing blocks of the controller in response to the flag signal having the active level.

As described above, in a display device according to an embodiment, a controller may divide a display region of a display panel into a normal region and a simple display region having only predetermined colors, and may generate a flag signal having an active level in a time period corresponding to the simple display region within a frame period. A gamma voltage generator may disable at least a portion of a plurality of amplifiers in the gamma voltage generator in response to the flag signal having the active level. Accordingly, power consumption of the display device may be reduced.

Further, in the display device according to an embodiment, the controller may divide the display region into the normal region and the simple display region, may generate the flag signal having the active level in the time period corresponding to the simple display region within the frame period, and may disable a plurality of processing blocks of the controller in response to the flag signal having the active level. Accordingly, the power consumption of the display device may be further reduced.

### BRIEF DESCRIPTION OF THE DRAWINGS

The above and other features of the present disclosure will become more apparent with reference to the descriptions below and the accompanying drawings.

FIG. 1 is a block diagram illustrating a display device according to an embodiment.

FIG. 2 is a block diagram illustrating an example of a gamma voltage generator included in a display device according to an embodiment.

FIG. 3 is a diagram for describing an example in which a flag signal is generated based on simple display region position information.

FIG. 4 is a diagram for describing an example in which a flag signal is generated by analyzing input image data.

FIG. 5A is a timing diagram illustrating an example of a flag signal, FIG. 5B is a block diagram for describing an example of an operation of a gamma voltage generator in a first time period, and FIG. 5C is a block diagram for describing an example of an operation of the gamma voltage generator in a second time period.

FIG. 6 is a block diagram illustrating a controller included in a display device according to an embodiment.

FIG. 7 is a block diagram illustrating a simple display processing block included in a controller of FIG. 6.

FIG. 8 is a timing diagram illustrating examples of a flag signal, a first internal clock signal provided to a plurality of processing blocks, and a second internal clock signal provided to a simple display processing block.

FIG. 9 is a block diagram illustrating a controller included in a display device according to an embodiment.

FIG. 10 is a block diagram illustrating a first simple display processing block included in a controller of FIG. 9.

FIG. 11 is a block diagram illustrating a second simple display processing block included in a controller of FIG. 9.

FIG. 12 is a block diagram illustrating an electronic device including a display device according to an embodiment.

### DETAILED DESCRIPTION OF THE EMBODIMENTS

The embodiments are described more fully hereinafter with reference to the accompanying drawings. Like or similar reference numerals refer to like or similar elements throughout.

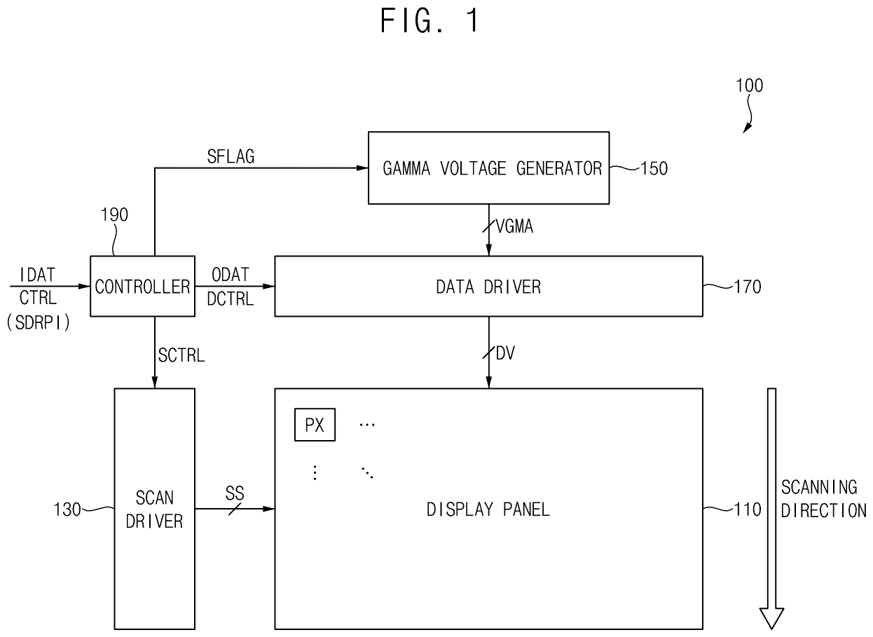

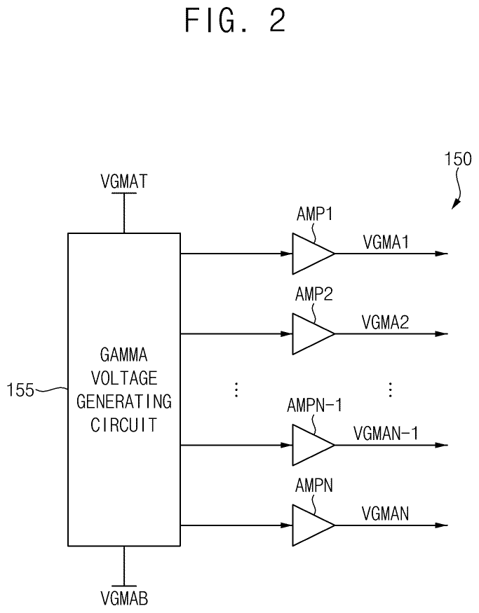

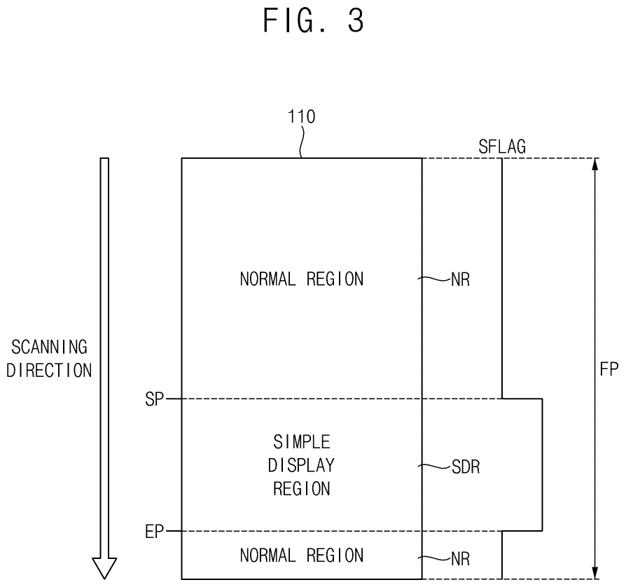

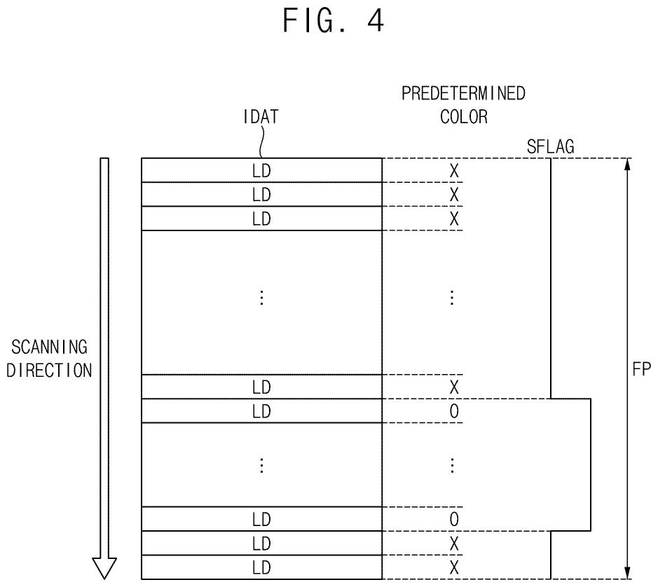

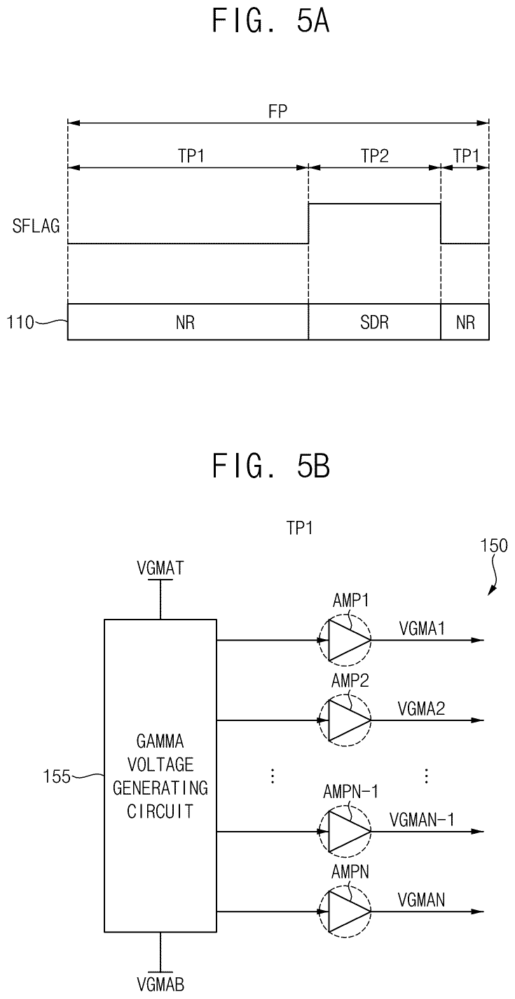

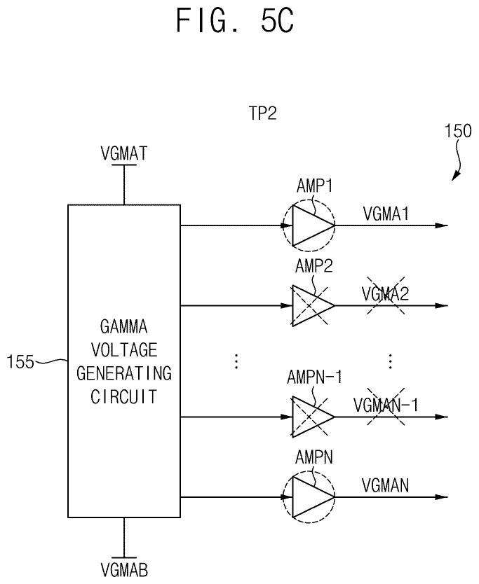

FIG. 1 is a block diagram illustrating a display device according to an embodiment, FIG. 2 is a block diagram illustrating an example of a gamma voltage generator included in a display device according to an embodiment, FIG. 3 is a diagram for describing an example in which a flag signal is generated based on simple display region position information, FIG. 4 is a diagram for describing an example in which a flag signal is generated by analyzing input image data, FIG. 5A is a timing diagram illustrating an example of a flag signal, FIG. 5B is a block diagram for describing an example of an operation of a gamma voltage generator in a first time period, and FIG. 5C is a block diagram for describing an example of an operation of the gamma voltage generator in a second time period.

Referring to FIG. 1, a display device 100 according to an embodiment may include a display panel 110 that includes a plurality of pixels PX, a scan driver 130 that provides scan signals SS to the plurality of pixels PX, a gamma voltage generator 150 that generates a plurality of gamma voltages VGMA, a data driver 170 that provides data voltages DV to the plurality of pixels PX based on the plurality of gamma voltages VGMA, and a controller 190 that controls the scan driver 130, the gamma voltage generator 150 and the data driver 170.

The display panel 110 may include a plurality of data lines, a plurality of scan lines, and a plurality of pixels PX connected to the plurality of data lines and the plurality of scan lines. In an embodiment, each pixel PX may include a light emitting element, and the display panel 110 may be a light emitting display panel. For example, the light emitting element may be an organic light emitting diode (OLED), and the display panel 110 may be an OLED display panel. In other examples, the light emitting element may be a nano light emitting diode (NED), a quantum dot (QD) light emitting diode, a micro light emitting diode, an inorganic light emitting diode, or any other suitable light emitting element. In other examples, each pixel PX may include a switching transistor and a liquid crystal capacitor connected to the switching transistor, and the display panel 110 may be a liquid crystal display (LCD) panel. However, the present disclosure is not limited thereto, and the display panel 110 of the present disclosure may be any suitable display panel.

The scan driver 130 may generate the scan signals SS based on a scan control signal SCTRL received from the controller 190, and may provide the scan signals SS to the plurality of pixels PX through the plurality of scan lines. The scan control signal SCTRL may include, but is not limited to, a scan start signal and a scan clock signal. In an embodiment, the scan driver 130 may sequentially provide scan signals SS to a plurality of pixels PX along a scanning direction. Here, the scanning direction may be a direction in which the scan signals SS are sequentially activated. For example, the scanning direction may be, but is not limited to, a direction from an uppermost pixel row to a lowermost pixel row among a plurality of pixel rows of the display panel 110. Further, in an embodiment, the scan driver 130 may be integrated or formed in the display panel 110. In an embodiment, the scan driver 130 may be implemented with one or more integrated circuits.

The gamma voltage generator 150 may generate the plurality of gamma voltages VGMA corresponding to a plurality of reference gray levels, and may provide the plurality of gamma voltages VGMA to the data driver 170 by using a plurality of amplifiers. For example, as illustrated in FIG. 2, the gamma voltage generator 150 may include a gamma voltage generating circuit 155 that generates first through N-th gamma voltages VGMA1, VGMA2, . . . , VGMAN−1 and VGMAN based on a gamma top voltage VGMAT and a gamma bottom voltage VGMAB, where N is an integer greater than 1, and first through N-th amplifiers AMP1, AMP2, . . . , AMPN−1 and AMPN that respectively output the first through N-th gamma voltages VGMA1, VGMA2, . . . , VGMAN−1 and VGMAN. In an embodiment, the gamma voltage generating circuit 155 may include, but is not limited to, at least one resistor string for dividing a voltage between the gamma top voltage VGMAT and the gamma bottom voltage VGMAB to generate divided voltages, and at least one multiplexer for selecting the divided voltages as the first through N-th gamma voltages VGMA1 through VGMAN. Further, the first through N-th amplifiers AMP1 through AMPN may be, but are not limited to, unity gain buffers that output input voltages as they are.

The data driver 170 may receive output image data ODAT and a data control signal DCTRL from the controller 190, may receive the plurality of gamma voltages VGMA from the gamma voltage generator 150, may generate gray level voltages respectively corresponding to a plurality of gray levels (e.g., two hundred and fifty six gray levels from a 0-gray level to a 255-gray level) based on the plurality of gamma voltages VGMA, and may provide the gray level voltages corresponding to the output image data ODAT as the data voltages DV to the plurality of pixels PX through the plurality of data lines in response to the data control signal DCTRL. In an embodiment, the data control signal DCTRL may include, but is not limited to, an output data enable signal, a horizontal start signal and a load signal. In an embodiment, the data driver 170 and the controller 190 may be implemented as a single integrated circuit, and the single integrated circuit may be referred to as a timing controller embedded data driver (TED). In an embodiment, the data driver 170 and the controller 190 may be implemented as separate integrated circuits.

The controller 190 (e.g., a timing controller) may receive input image data IDAT and a control signal CTRL from an external host processor (e.g., an application processor (AP), a graphics processing unit (GPU), or a graphics card). The input image data IDAT may be, but is not limited to, RGB image data including red image data, green image data and blue image data. Further, the control signal CTRL may include, but is not limited to, a vertical synchronization signal, a horizontal synchronization signal, an input data enable signal, a master clock signal, etc. In an embodiment, the control signal CTRL may further include, but is not limited to, simple display region position information SDRP1 indicating a position of a simple display region having only predetermined colors. The controller 190 may generate the output image data ODAT, the data control signal DCTRL and the scan control signal SCTRL based on the input image data IDAT and the control signal CTRL. The controller 190 may control an operation of the data driver 170 by providing the output image data ODAT and the data control signal DCTRL to the data driver 170, and may control an operation of the scan driver 130 by providing the scan control signal SCTRL to the scan driver 130.

In the display device 100 according to an embodiment, the controller 190 may determine a simple display region within a display region of the display panel 110. In other words, the controller 190 may divide the display region into a normal region and the simple display region. Here, the simple display region may be a region having only predetermined colors, or a region that displays an image having only the predetermined colors. For example, the simple display region may be, but is not limited to, a simple user interface (UI) region (e.g., a keyboard region) or a fixed image region (e.g., a menu region). Further, in an embodiment, the predetermined colors may be, but are not limited to, a black color and a white color. In an embodiment, the predetermined colors may be, but are not limited to, a black color, a white color, a red color, a green color, a blue color, a yellow color, a cyan color and a magenta color.

In an embodiment, the controller 190 may receive the simple display region position information SDRP1 indicating the position of the simple display region from the host processor, and may divide the display region of the display panel 110 into the normal region and the simple display region based on the simple display region position information SDRP1. For example, as illustrated in FIG. 3, the simple display region position information SDRP1 may indicate a start position SP of the simple display region SDR and an end position EP of the simple display region SDR. For example, the start position SP may indicate a position of the uppermost pixel row among pixel rows within the simple display region SDR, and the end position EP may indicate a position of the lowermost pixel row among the pixel rows within the simple display region SDR. The controller 190 may determine a region having the start position SP and the end position EP indicated by the simple display region position information SDRP1 as the simple display region SDR, and may determine a region of the display region excluding the simple display region SDR as the normal region NR.

In an embodiment, the controller 190 may divide the display region of the display panel 110 into the normal region NR and the simple display region SDR by analyzing the input image data IDAT for the display panel 110. For example, as illustrated in FIG. 4, the controller 190 may divide the input image data IDAT for the display panel 110 into a plurality of line data LD for a plurality of pixel rows of the display panel 110. Further, with respect to each line data LD, the controller 190 may determine whether each of a plurality of pixel data included in the line data LD represents one of the predetermined colors. If any one of the plurality of pixel data represents a color other than the predetermined colors, the controller 190 may determine that the line data LD is for the normal region NR. If all of the pixel data represent only one or more of the predetermined colors, the controller 190 may determine that the line data LD is for the simple display region SDR. In an embodiment, the controller 190 may determine that the line data LD is for the simple display region SDR if all of the pixel data indicate only the predetermined colors in two or more consecutive frame periods, but is not limited thereto. Further, in an embodiment, if the line data LD for two or more consecutive pixel rows are determined to be for the simple display region SDR, the controller 190 may determine that the two or more consecutive pixel rows are for the simple display region SDR, but is not limited thereto.

In an example, if the line data LD for a first predetermined number or more of consecutive pixel rows indicate only the black color, the controller 190 may determine that the first predetermined number or more of consecutive pixel rows are an upper region of a keyboard region. Further, if the line data LD for subsequent continuous pixel rows indicate the black and white colors, the controller 190 may determine that the subsequent continuous pixel rows are a middle region of the keyboard region. In addition, if the line data LD for a second predetermined number or more of continuous pixel rows subsequent to the middle region indicate only the black color, the controller 190 may determine that the second predetermined number or more of continuous pixel rows are a lower region of the keyboard region. In this manner, the controller 190 may determine the keyboard region as the simple display region SDR, but is not limited thereto. Although an example of the keyboard region is described above as the simple display region SDR, the simple display region SDR in the display device 100 according to an embodiment is not limited to the keyboard region. That is, the simple display region SDR in the display device 100 according to an embodiment may be any region that displays an image having only the predetermined colors. For example, the simple display region SDR may include, but is not limited to, a simple UI region, a menu region, etc.

Further, the controller 190 may generate a flag signal SFLAG having an active level in a time period corresponding to the simple display region SDR within a frame period FP. For example, as illustrated in FIG. 3, the controller 190 may divide the display region of the display panel 110 into the normal region NR and the simple display region SDR based on the simple display region position information SDRP1, and may generate the flag signal SFLAG that has an inactive level (e.g., a low level) in a time period corresponding to the normal region NR within the frame period FP, and that has the active level (e.g., a high level) in a time period corresponding to the simple display region SDR within the frame period FP. In another example, as illustrated in FIG. 4, the controller 190 may divide the display region of the display panel 110 into the normal region NR and the simple display region SDR by analyzing the input image data IDAT, and may generate the flag signal SFLAG that has the inactive level in a time period corresponding to the normal region NR within the frame period FP, and that has the active level in a time period corresponding to the simple display region SDR within the frame period FP.

In the display device 100 according to an embodiment, the controller 190 may provide the flag signal SFLAG to the gamma voltage generator 150, and the gamma voltage generator 150 may disable at least a portion of the plurality of amplifiers AMP1 through AMPN in response to the flag signal SFLAG having the active level.

For example, as illustrated in FIG. 5A, a frame period FP may be divided into a first time period TP1 corresponding to the normal region NR, or in which the scan signals SS are applied to pixel rows of the normal region NR, and a second time period TP2 corresponding to the simple display region SDR, or in which the scan signals SS are applied to pixel rows of the simple display region SDR. Further, the flag signal SFLAG may have the inactive level (e.g., the low level) in the first time period TP1 corresponding to the normal region NR, and may have the active level (e.g., the high level) in the second time period TP2 corresponding to the simple display region SDR.

Further, in the first time period TP1 in which the flag signal SFLAG has the inactive level, as illustrated in FIG. 5B, all amplifiers AMP1 through AMPN of the gamma voltage generator 150 may be enabled, and the gamma voltage generator 150 may output all the gamma voltages VGMA, or the first through N-th gamma voltages VGMA1, VGMA2, . . . , VGMAN−1 and VGMAN.

In the second time period TP2 in which the flag signal SFLAG has the active level, as illustrated in FIG. 5C, an uppermost amplifier AMP1 that outputs an uppermost gamma voltage VGMA1 among the plurality of gamma voltages VGMA1 through VGMAN and a lowermost amplifier AMPN that outputs a lowermost gamma voltage VGMAN among the plurality of gamma voltages VGMA1 through VGMAN may be maintained in an enable state, but intermediate amplifiers VGMA2, . . . , VGMAN−1 that output intermediate gamma voltages VGMA2, . . . , VGMAN−1 between the uppermost gamma voltage VGMA1 and the lowermost gamma voltage VGMAN among the plurality of amplifiers AMP1 through AMPN may be disabled. For example, in response to the flag signal SFLAG having the active level, the gamma voltage generator 150 may disable the intermediate amplifiers VGMA2, . . . , VGMAN−1 by not providing a power supply voltage to the intermediate amplifiers VGMA2, . . . , VGMAN−1. Thus, in the second time period TP2 in which the flag signal SFLAG has the active level, the gamma voltage generator 150 may provide only the uppermost gamma voltage VGMA1 and the lowermost gamma voltage VGMAN to the data driver 170. In an example, when a driving transistor of each pixel PX is an N-type metal oxide semiconductor (NMOS) transistor, the uppermost gamma voltage VGMA1 may be a data voltage DV corresponding to the maximum gray level (e.g., a 255-gray level), and the lowermost gamma voltage VGMAN may be a data voltage DV corresponding to the minimum gray level (e.g., a 0-gray level), but are not limited thereto. In another example, when a driving transistor of each pixel PX is a P-type metal oxide semiconductor (PMOS) transistor, the uppermost gamma voltage VGMA1 may be a data voltage DV corresponding to the minimum gray level, and the lowermost gamma voltage VGMAN may be a data voltage DV corresponding to the maximum gray level, but are not limited thereto. As described above, in the second time period TP2 corresponding to the simple display region SDR within the frame period FP, the intermediate amplifiers VGMA2, . . . , VGMAN−1 may be disabled, and thus the power consumption of the gamma voltage generator 150 and the display device 100 may be reduced.

Although FIG. 5C illustrates an example in which the uppermost amplifier AMP1 and the lowermost amplifier AMPN are enabled in the second time period TP2 corresponding to the simple display region SDR, and the intermediate amplifiers VGMA2, . . . , VGMAN−1 between the uppermost amplifier AMP1 and the lowermost amplifier AMPN are disabled, the display device 100 according to an embodiment is not limited to the example of FIG. 5C. In an embodiment, in response to the flag signal SFLAG having the active level, the gamma voltage generator 150 may maintain 2^{M} amplifiers among the plurality of amplifiers in an enable state, where M is an integer greater than 0, and may disable the remaining amplifiers except for the 2^{M} amplifiers among the plurality of amplifiers. For example, the 2^{M} amplifiers maintained in the enable state may be, but are not limited to, amplifiers corresponding to upper M bits of each pixel data of the input image data IDAT.

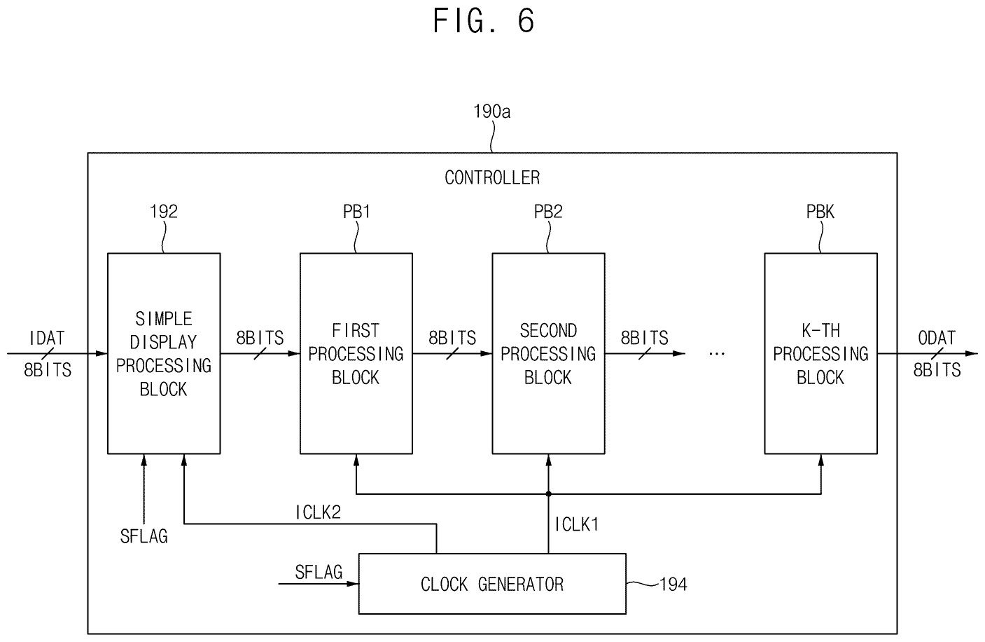

Further, in the display device 100 according to an embodiment, as will be described below with reference to FIGS. 6 through 11, the controller 190 may disable a plurality of processing blocks of the controller 190 in response to the flag signal SFLAG having the active level. Accordingly, in the second time period TP2 corresponding to the simple display region SDR within the frame period FP, the power consumption of the controller 190 and the display device 100 may be further reduced.

In a conventional display device, all amplifiers of a gamma voltage generator may be enabled in a normal mode. However, in the display device 100 according to an embodiment, the controller 190 may divide the display region of the display panel 110 into the normal region NR and the simple display region SDR, may generate the flag signal SFLAG having the active level in the second time period TP2 corresponding to the simple display region SDR within the frame period FP, and may disables at least a portion of the plurality of amplifiers AMP1 through AMPN of the gamma voltage generator 150 in response to the flag signal SFLAG having the active level.

Accordingly, in an embodiment of the present disclosure, the power consumption of the display device 100 may be reduced. Further, in the display device 100 according to an embodiment, the controller 190 may disable the plurality of processing blocks of the controller 190 in response to the flag signal SFLAG having the active level. Accordingly, the power consumption of the display device 100 may be further reduced.

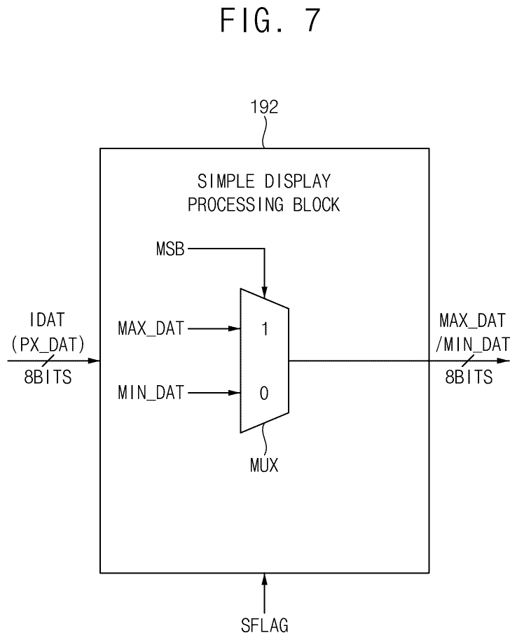

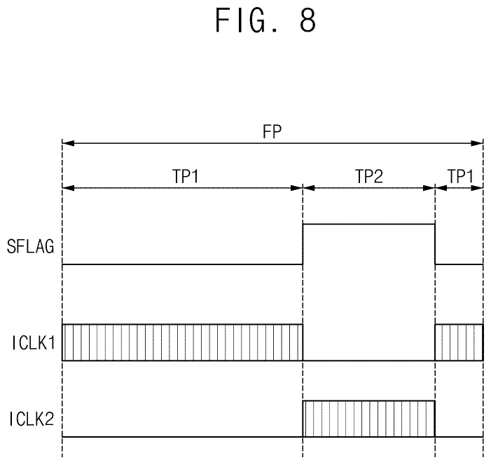

FIG. 6 is a block diagram illustrating a controller included in a display device according to an embodiment, FIG. 7 is a block diagram illustrating a simple display processing block included in a controller of FIG. 6, and FIG. 8 is a timing diagram illustrating examples of a flag signal, a first internal clock signal provided to a plurality of processing blocks, and a second internal clock signal provided to a simple display processing block.

Referring to FIG. 6, a controller 190a included in a display device according to an embodiment may include a simple display processing block 192, and a plurality of processing blocks PB1, PB2, . . . , PBK located subsequent to the simple display processing block 192. In an embodiment, the controller 190a may further include a clock generator 194 that provides internal clock signals ICLK1 and ICLK2 to the simple display processing block 192 and the plurality of processing blocks PB1 through PBK.

The simple display processing block 192 may convert input image data IDAT for each pixel, or pixel data into maximum gray level data or minimum gray level data in response to a flag signal SFLAG. For example, the simple display processing block 192 may output the input image data IDAT as it is when the flag signal SFLAG has an inactive level (e.g., a low level), and may convert each pixel data included in the input image data IDAT into the maximum gray level data or the minimum gray level data when the flag signal SFLAG has an active level (e.g., a high level). Here, the maximum gray level data may have a value (e.g., 255) corresponding to the maximum gray level (e.g., a 255-gray level), and the minimum gray level data may have a value (e.g., 0) corresponding to the minimum gray level (e.g., a 0-gray level).

In an embodiment, as illustrated in FIG. 7, the simple display processing block 192 may include a multiplexer MUX that outputs the maximum gray level data MAX_DAT or the minimum gray level data MIN_DAT according to a most significant bit MSB of each pixel data PX_DAT included in the input image data IDAT. While the flag signal SFLAG has the inactive level, the simple display processing block 192 may output the input image data IDAT as it is. In contrast, while the flag signal SFLAG has the active level, in a case where the most significant bit MSB of the pixel data PX_DAT has a value of 1, the multiplexer MUX of the simple display processing block 192 may convert the pixel data PX_DAT into the maximum gray level data MAX_DAT, and may output the maximum gray level data MAX_DAT. Further, in a case where the most significant bit MSB of the pixel data PX_DAT has a value of 0, the multiplexer MUX of the simple display processing block 192 may convert the pixel data PX_DAT into the minimum gray level data MIN_DAT, and may output the minimum gray level data MIN_DAT. Although FIG. 7 illustrates an example in which the simple display processing block 192 sequentially receives a plurality of pixel data PX_DAT each having eight bits as the input image data IDAT, the simple display processing block 192 is not limited to the example of FIG. 7. Further, although FIG. 7 illustrates an example in which the simple display processing block 192 sequentially outputs a plurality of pixel data PX_DAT each having eight bits while the flag signal SFLAG has the inactive level, and outputs the maximum gray level data MAX_DAT having eight bits or the minimum gray level data MIN_DAT having eight bits instead of each pixel data PX_DAT while the flag signal SFLAG has the active level, the simple display processing block 192 is not limited to the example of FIG. 7.

The plurality of processing blocks PB1 through PBK may be located subsequent to the simple display processing block 192, and may perform data processing operations on the input image data IDAT output from the simple display processing block 192 while the flag signal SFLAG has the inactive level. In an embodiment, the plurality of processing blocks PB1 through PBK may include, but are not limited to, an image quality enhancement block that performs an image quality enhancement operation, a compensation block that performs a compensation operation, and a dithering block that performs a dithering operation. Although FIG. 6 illustrates an example in which a controller 190a includes first through K-th processing blocks PB1 through PBK, where K is an integer greater than 0, the number of the processing blocks PB1 through PBK included in the controller 190a is not limited to the example of FIG. 6. Further, although FIG. 6 illustrates an example in which the pixel data PX_DAT, the maximum gray level data MAX_DAT or the minimum gray level data MIN_DAT are transferred in eight-bit units within the plurality of processing blocks PB1 through PBK, the controller 190a according to an embodiment is not limited to the example of FIG. 6.

The clock generator 194 may generate first and second internal clock signals ICLK1 and ICLK2 for an operation of the controller 190a, may provide the first internal clock signal ICLK1 to the plurality of processing blocks PB1 through PBK, and may provide the second internal clock signal ICLK2 to the simple display processing block 192.

In the display device according to an embodiment, in response to the flag signal SFLAG having the inactive level, the controller 190a may disable the simple display processing block 192, and may enable the plurality of processing blocks PB1 through PBK. In this case, the simple display processing block 192 may output the input image data IDAT as is, and the plurality of processing blocks PB1 through PBK may perform the data processing operations for the input image data IDAT. Further, in response to the flag signal SFLAG having the active level, the controller 190a may enable the simple display processing block 192, and may disable the plurality of processing blocks PB1 through PBK. In this case, the simple display processing block 192 may convert each pixel data PX_DAT into the maximum gray level data MAX_DAT or the minimum gray level data MIN_DAT, and the plurality of processing blocks PB1 through PBK may output the maximum gray level data MAX_DAT or the minimum gray level data MIN_DAT as is. To perform these operations, in an embodiment, the clock generator 194 may selectively activate the first internal clock signal ICLK1 or the second internal clock signal ICLK2 according to the flag signal SFLAG.

For example, as illustrated in FIG. 8, in a first time period TP1 corresponding to a normal region within a frame period FP, the flag signal SFLAG may have the inactive level (e.g., the low level). In response to the flag signal SFLAG having the inactive level, the clock generator 194 may provide the plurality of processing blocks PB1 through PBK with the first internal clock signal ICLK1 that periodically toggles. However, in response to the flag signal SFLAG having the inactive level, the clock generator 194 may deactivate the second internal clock signal ICLK2 provided to the simple display processing block 192, or may not provide the second internal clock signal ICLK2 to the simple display processing block 192. Accordingly, in the first time period TP1, the simple display processing block 192 may be disabled, and the plurality of processing blocks PB1 through PBK may be enabled. Even if the simple display processing block 192 does not receive the second internal clock signal ICLK2, the simple display processing block 192 may output received data as it is in response to another signal (e.g., a clock signal different from the second internal clock signal ICLK2).

Further, in a second time period TP2 corresponding to a simple display region within the frame period FP, the flag signal SFLAG may have the active level (e.g., the high level). In response to the flag signal SFLAG having the active level, the clock generator 194 may provide the simple display processing block 192 with the second internal clock signal ICLK2 that periodically toggles. However, in response to the flag signal SFLAG having the active level, the clock generator 194 may deactivate the first internal clock signal ICLK1 provided to the plurality of processing blocks PB1 through PBK, or may not provide the first internal clock signal ICLK1 to the plurality of processing blocks PB1 through PBK. Accordingly, in the second time period TP2, the simple display processing block 192 may be enabled, and the plurality of processing blocks PB1 through PBK may be disabled. Even if each processing block PB1 through PBK does not receive the first internal clock signal ICLK1, each processing block PB1 through PBK may output the received data as it is in response to another signal (e.g., a clock signal different from the first internal clock signal ICLK1).

As described above, in the display device according to an embodiment, the controller 190a may generate the flag signal SFLAG having the active level in the second time period TP2 corresponding to the simple display region within the frame period FP, and may disable the plurality of processing blocks PB1 through PBK in response to the flag signal SFLAG having the active level. Accordingly, in the second time period TP2 corresponding to the simple display region within the frame period FP, the power consumption of the controller 190a and the display device may be reduced.

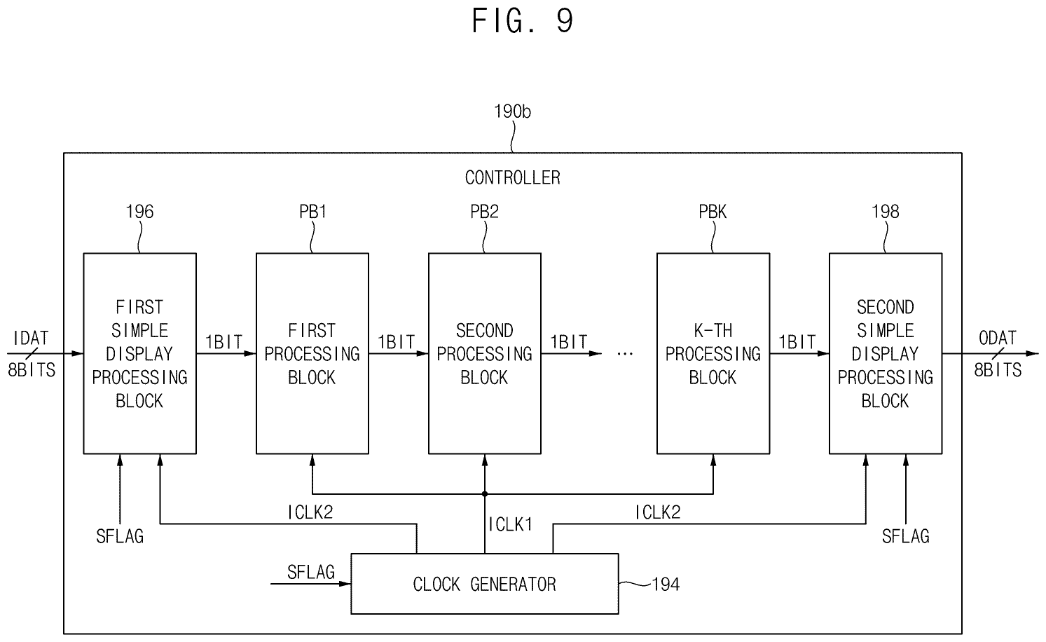

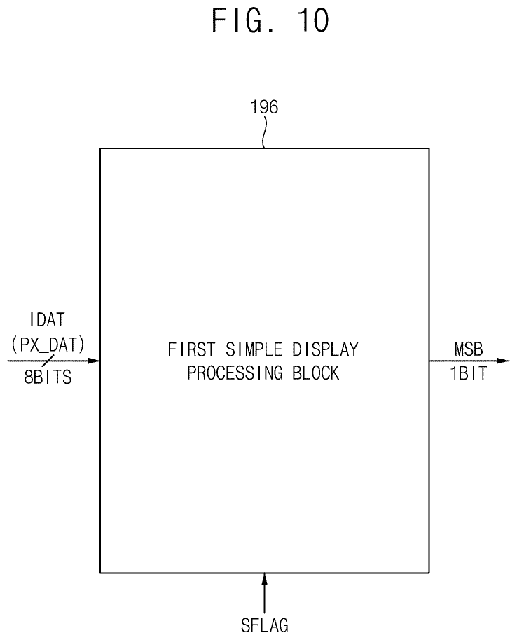

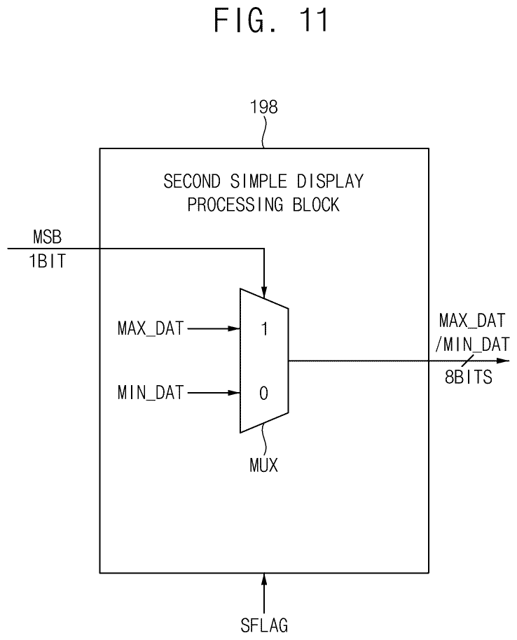

FIG. 9 is a block diagram illustrating a controller included in a display device according to an embodiment, FIG. 10 is a block diagram illustrating a first simple display processing block included in a controller of FIG. 9, and FIG. 11 is a block diagram illustrating a second simple display processing block included in a controller of FIG. 9.

Referring to FIG. 9, a controller 190b included in a display device according to an embodiment may include a first simple display processing block 196, a plurality of processing blocks PB1 through PBK located subsequent to the first simple display processing block 196, a second simple display processing block 198 located subsequent to the plurality of processing blocks PB1 through PBK, and a clock generator 194. The controller 190b of FIG. 9 may have a similar configuration and a similar operation to a controller 190a of FIG. 6, except that the controller 190b may include the first and second simple display processing blocks 196 and 198 instead of a simple display processing block 192 illustrated in FIG. 6.

The first simple display processing block 196 may be located in front of the plurality of processing blocks PB1 through PBK. As illustrated in FIG. 10, the first simple display processing block 196 may sequentially receive a plurality of pixel data PX_DAT included in input image data IDAT. Further, each pixel data PX_DAT may have eight bits, but is not limited thereto. While a flag signal SFLAG has an inactive level (e.g., a low level), the first simple display processing block 196 may sequentially output a plurality of pixel data PX_DAT each having 8 bits. However, while the flag signal SFLAG has an active level (e.g., a high level), the first simple display processing block 196 may output only a most significant bit MSB of each pixel data PX_DAT. Thus, while the flag signal SFLAG has the active level, the first simple display processing block 196 may provide the plurality of processing blocks PB1 through PBK with only the most significant bit MSB, i.e., one bit.

The plurality of processing blocks PB1 through PBK may be located subsequent to the first simple display processing block 196, and may perform data processing operations on the input image data IDAT, or the plurality of pixel data PX_DAT output from the first simple display processing block 196 while the flag signal SFLAG has the inactive level. However, while the flag signal SFLAG has the active level, each processing block PB1 through PBK may receive the most significant bit MSB of the pixel data PX_DAT, and may output the most significant bit MSB as it is to a subsequent processing block or the second simple display processing block 198. That is, while the flag signal SFLAG has the active level, the plurality of processing blocks PB1 through PBK may be disabled such that the plurality of processing blocks PB1 through PBK may not perform the data processing operations. Further, while the flag signal SFLAG has the active level, unlike the controller 190a of FIG. 6 in which 8-bit data is transferred, the controller 190b of FIG. 9 may transfer only the most significant bit MSB or one bit to the plurality of processing blocks PB1 through PBK. Accordingly, while the flag signal SFLAG has the active level, the power consumption of the controller 190b and the display device may be further reduced.

The second simple display processing block 198 may be located subsequent to the plurality of processing blocks PB1 through PBK, and may output, as output image data ODAT, image data received from the plurality of processing blocks PB1 through PBK as it is while the flag signal SFLAG has the inactive level. However, while the flag signal SFLAG has the active level, as illustrated in FIG. 11, the second simple display processing block 198 may receive the most significant bit MSB of the pixel data PX_DAT, and may output maximum gray level data MAX_DAT or minimum gray level data MIN_DAT according to the most significant bit MSB. To perform this operation, the second simple display processing block 198 may include a multiplexer MUX that outputs the maximum gray level data MAX_DAT or the minimum gray level data MIN_DAT according to the most significant bit MSB of each pixel data PX_DAT. That is, while the flag signal SFLAG has the active level, the second simple display processing block 198 may receive only one bit, or the most significant bit MSB, and may output the maximum gray level data MAX_DAT or the minimum gray level data MIN_DAT having eight bits.

The clock generator 194 may generate first and second internal clock signals ICLK1 and ICLK2 for an operation of the controller 190b, may provide the first internal clock signal ICLK1 to the plurality of processing blocks PB1 through PBK, and may provide the second internal clock signal ICLK2 to the first and second simple display processing blocks 196 and 198. In an embodiment, in response to the flag signal SFLAG having the inactive level, the clock generator 194 may provide the plurality of processing blocks PB1 through PBK with the first internal clock signal ICLK1 that periodically toggles. However, in response to the flag signal SFLAG having the inactive level, the clock generator 194 may deactivate the second internal clock signal ICLK2 provided to the first and second simple display processing blocks 196 and 198, or may not provide the second internal clock signal ICLK2 to the first and second simple display processing blocks 196 and 198. Accordingly, in a first time period corresponding to a normal region, the first and second simple display processing blocks 196 and 198 may be disabled, and the plurality of processing blocks PB1 through PBK may be enabled. Further, in response to the flag signal SFLAG having the active level, the clock generator 194 may provide the first and second simple display processing blocks 196 and 198 with the second internal clock signal ICLK2 that periodically toggles. However, in response to the flag signal SFLAG having the active level, the clock generator 194 may deactivate the first internal clock signal ICLK1 provided to the plurality of processing blocks PB1 through PBK, or may not provide the first internal clock signal ICLK1 to the plurality of processing blocks PB1 through PBK. Accordingly, in a second time period corresponding to a simple display region, the first and second simple display processing blocks 196 and 198 may be enabled, and the plurality of processing blocks PB1 through PBK may be disabled.

As described above, in the display device according to an embodiment, the controller 190b may generate the flag signal SFLAG having the active level in the second time period corresponding to the simple display region, and may disable the plurality of processing blocks PB1 through PBK in response to the flag signal SFLAG having the active level. Further, in the second time period corresponding to the simple display region, only the most significant bit MSB, or one bit may be transferred within the plurality of processing blocks PB1 through PBK. Accordingly, in the second time period corresponding to the simple display region, the power consumption of the controller 190b and the display device may be further reduced.

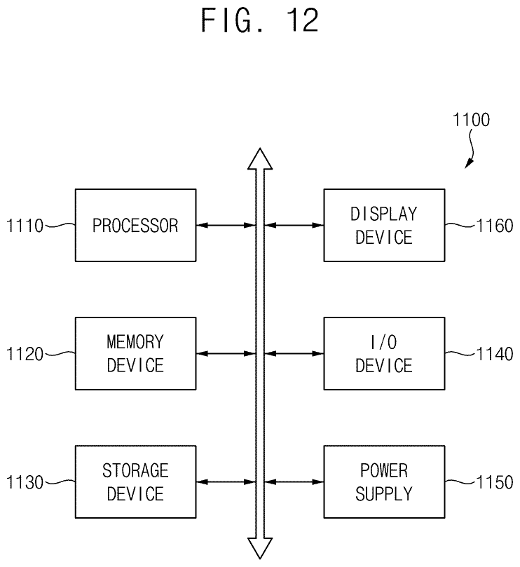

FIG. 12 is a block diagram illustrating an electronic device including a display device according to an embodiment.

Referring to FIG. 12, an electronic device 1100 may include a processor 1110, a memory device 1120, a storage device 1130, an input/output (I/O) device 1140, a power supply 1150, and a display device 1160. The electronic device 1100 may further include a plurality of ports for communicating with a video card, a sound card, a memory card, a universal serial bus (USB) device, other electric devices, etc.

The processor 1110 may perform various computing functions or tasks. The processor 1110 may be an application processor (AP), a micro-processor, a central processing unit (CPU), etc. The processor 1110 may be coupled to other components via an address bus, a control bus, a data bus, etc. Further, in some embodiments, the processor 1110 may be further coupled to an extended bus such as a peripheral component interconnection (PCI) bus.

The memory device 1120 may store data for operations of the electronic device 1100. For example, the memory device 1120 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc, and/or at least one volatile memory device such as a dynamic random access memory (DRAM) device, a static random access memory (SRAM) device, a mobile dynamic random access memory (mobile DRAM) device, etc.

The storage device 1130 may be a solid state drive (SSD) device, a hard disk drive (HDD) device, a CD-ROM device, etc. The I/O device 1140 may be an input device such as a keyboard, a keypad, a mouse, a touch screen, etc, and an output device such as a printer, a speaker, etc. The power supply 1150 may supply power for operations of the electronic device 1100. The display device 1160 may be coupled to other components through the buses or other communication links.

In the display device 1160, a controller may divide a display region of a display panel into a normal region and a simple display region having only predetermined colors, and may generate a flag signal having an active level in a time period corresponding to the simple display region within a frame period. A gamma voltage generator may disable at least a portion of a plurality of amplifiers in the gamma voltage generator in response to the flag signal having the active level. Accordingly, power consumption of the display device may be reduced. Further, in the display device 1160, the controller may disable a plurality of processing blocks of the controller in response to the flag signal having the active level. Accordingly, the power consumption of the display device may be further reduced.

The feature of an embodiment of the present disclosure may be applied to any display device 1160, and any electronic device 1100 including the display device 1160. For example, the feature of the present disclosure may be applied to a mobile phone, a smart phone, a tablet computer, a wearable electronic device, a virtual reality (VR) device, a television (TV) (e.g., a digital TV, a 3D TV, etc.), a personal computer (PC), a home appliance, a laptop computer, a personal digital assistant (PDA), a portable multimedia player (PMP), a digital camera, a music player, a portable game console, a navigation device, etc.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. Therefore, it is to be understood that the foregoing is illustrative of various embodiments and is not to be construed as limited to the specific embodiments disclosed herein, and that modifications to the disclosed embodiments, as well as other embodiments, are intended to be included within the scope of the appended claims.

What is claimed is:

1. A display device comprising:
a display panel including a plurality of pixels;
a scan driver connected to the plurality of pixels and providing scan signals to the plurality of pixels;
a gamma voltage generator including a plurality of amplifiers that output a plurality of gamma voltages;
a data driver connected to the gamma voltage generator, the data driver generating data voltages based on the plurality of gamma voltages, and providing the data voltages to the plurality of pixels; and
a controller connected to the scan driver, the gamma voltage generator and the data driver, the controller controlling the scan driver, the gamma voltage generator and the data driver, dividing a display region of the display panel into a normal region and a simple display region having only predetermined colors, and generating a flag signal having an active level in a time period corresponding to the simple display region within a frame period,
wherein the gamma voltage generator is configured to disable at least a portion of the plurality of amplifiers in response to the flag signal having the active level.

2. The display device of claim 1, wherein the plurality of amplifiers includes an uppermost amplifier configured to output an uppermost gamma voltage among the plurality of gamma voltages, a lowermost amplifier configured to output a lowermost gamma voltage among the plurality of gamma voltages, and intermediate amplifiers configured to output intermediate gamma voltages between the uppermost gamma voltage and the lowermost gamma voltage among the plurality of gamma voltages, and
wherein, in response to the flag signal having the active level, the gamma voltage generator maintains the uppermost amplifier and the lowermost amplifier in an enable state, and disables the intermediate amplifiers.

3. The display device of claim 1, wherein, in response to the flag signal having the active level, the gamma voltage generator maintains 2^{M} amplifiers among the plurality of amplifiers in an enable state, where M is an integer greater than 0, and disables remaining amplifiers except for the 2^{M} amplifiers among the plurality of amplifiers.

4. The display device of claim 1, wherein the controller receives simple display region position information indicating a position of the simple display region from a host processor, and divides the display region of the display panel into the normal region and the simple display region based on the simple display region position information.

5. The display device of claim 1, wherein the controller divides the display region of the display panel into the normal region and the simple display region by analyzing input image data for the display panel.

6. The display device of claim 5, wherein the controller divides the input image data for the display panel into a plurality of line data for a plurality of pixel rows of the display panel, and
wherein, with respect to each line data of the plurality of line data, the controller determines whether each of a plurality of pixel data included in the line data represents one of the predetermined colors, determines that the line data is for the normal region when any one of the plurality of pixel data represents a color other than the predetermined colors, and determines that the line data is for the simple display region when all of the plurality of pixel data represent the predetermined colors.

7. The display device of claim 6, wherein the predetermined colors are a black color and a white color.

8. The display device of claim 6, wherein the predetermined colors are a black color, a white color, a red color, a green color, a blue color, a yellow color, a cyan color and a magenta color.

9. The display device of claim 1, wherein the controller includes:
a simple display processing block configured to convert input image data for each of the plurality of pixels into maximum gray level data or minimum gray level data; and
a plurality of processing blocks located subsequent to the simple display processing block, and configured to perform data processing operations, and
wherein, in response to the flag signal having the active level, the controller enables the simple display processing block, and disables the plurality of processing blocks.

10. The display device of claim 9, wherein, in response to the flag signal having the active level, the simple display processing block converts the input image data for each of the plurality of pixels into the maximum gray level data when a most significant bit of the input image data has a value of 1, and converts the input image data for each of the plurality of pixels into the minimum gray level data when the most significant bit of the input image data has a value of 0.

11. The display device of claim 9, wherein the controller further includes:
a clock generator configured to provide an internal clock signal to the simple display processing block and the plurality of processing blocks, and
wherein, in response to the flag signal having the active level, the clock generator provides the internal clock signal to the simple display processing block, and does not provide the internal clock signal to the plurality of processing blocks.

12. The display device of claim 1, wherein the controller includes:
a first simple display processing block configured to receive input image data for each of the plurality of pixels, and to output a most significant bit of the input image data for each of the plurality of pixels;
a plurality of processing blocks located subsequent to the first simple display processing block, and configured to perform data processing operations; and
a second simple processing display block located subsequent to the plurality of processing blocks, and configured to output maximum gray level data or minimum gray level data according to the most significant bit, and
wherein, in response to the flag signal having the active level, the controller enables the first and second simple display processing blocks, and disables the plurality of processing blocks.

13. The display device of claim 12, wherein the controller further includes:
a clock generator configured to provide an internal clock signal to the first simple display processing block, the plurality of processing blocks and the second simple display processing block, and
wherein, in response to the flag signal having the active level, the clock generator provides the internal clock signal to the first and second simple display processing blocks, and does not provide the internal clock signal to the plurality of processing blocks.

14. A display device comprising:
a display panel including a plurality of pixels;
a scan driver connected to the plurality of pixels and providing scan signals to the plurality of pixels;
a data driver connected to the plurality of pixels and providing data voltages to the plurality of pixels; and
a controller connected to the scan driver and the data driver, the controller controlling the scan driver and the data driver, dividing a display region of the display panel into a normal region and a simple display region having only predetermined colors, generating a flag signal having an active level in a time period corresponding to the simple display region within a frame period, and disabling a plurality of processing blocks of the controller in response to the flag signal having the active level.

15. The display device of claim 14, wherein the controller includes:
the plurality of processing blocks configured to perform data processing operations; and
a clock generator configured to provide an internal clock signal to the plurality of processing blocks, and
wherein, in response to the flag signal having the active level, the clock generator does not provide the internal clock signal to the plurality of processing blocks.

16. The display device of claim 15, wherein the controller further includes:
a simple display processing block located in front of the plurality of processing blocks, and configured to convert input image data for each of the plurality of pixels into maximum gray level data or minimum gray level data.

17. The display device of claim 15, wherein the controller further includes:
a first simple display processing block located in front of the plurality of processing blocks, configured to receive input image data for each of the plurality of pixels, and configured to output a most significant bit of the input image data for each of the plurality of pixels; and
a second simple processing display block located subsequent to the plurality of processing blocks, and configured to output maximum gray level data or minimum gray level data according to the most significant bit.

18. The display device of claim 14, further comprising:
a gamma voltage generator including a plurality of amplifiers that output a plurality of gamma voltages,
wherein the gamma voltage generator is configured to disable at least a portion of the plurality of amplifiers in response to the flag signal having the active level.

19. The display device of claim 18, wherein the plurality of amplifiers includes an uppermost amplifier configured to output an uppermost gamma voltage among the plurality of gamma voltages, a lowermost amplifier configured to output a lowermost gamma voltage among the plurality of gamma voltages, and intermediate amplifiers configured to output intermediate gamma voltages between the uppermost gamma voltage and the lowermost gamma voltage among the plurality of gamma voltages, and
wherein, in response to the flag signal having the active level, the gamma voltage generator maintains the uppermost amplifier and the lowermost amplifier in an enable state, and disables the intermediate amplifiers.

20. A display device comprising:
a display panel including a plurality of pixels;
a scan driver connected to the plurality of pixels and providing scan signals to the plurality of pixels;
a gamma voltage generator including a plurality of amplifiers that output a plurality of gamma voltages;
a data driver connected to the gamma voltage generator, the data driver generating data voltages based on the plurality of gamma voltages, and providing the data voltages to the plurality of pixels; and
a controller connected to the scan driver, the gamma voltage generator and the data driver, the controller controlling the scan driver, the gamma voltage generator and the data driver, dividing a display region of the display panel into a normal region and a simple display region having only predetermined colors, and generating a flag signal having an active level in a time period corresponding to the simple display region within a frame period,
wherein the gamma voltage generator is configured to disable at least a portion of the plurality of amplifiers in response to the flag signal having the active level, and
wherein the controller is further configured to disable a plurality of processing blocks of the controller in response to the flag signal having the active level.
